(19) United States
(12) Patent Application Publication
(10) Pub. No.: US 2006/0160978 A1
(43) Pub. Date: Jul. 20, 2006

(54) Flame retardant systems, and related methods and uses

(76) Inventors: Laxmi C. Gupta, Los Alamitos, CA (US); Ashish Dhuldhoya, Chino Hills, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/337,053

(22) Filed: Jan. 19, 2006

Related U.S. Application Data
(60) Provisional application No. 60/645,331, filed on Jan. 20, 2005.

(51) Int. Cl. C08G 18/00

(52) U.S. Cl. 528/44

(57) ABSTRACT

The present invention relates to flame retardant systems that include a combination of at least two flame retardant ingredients that is more effective than either flame retardant ingredient alone in a two-part, isocyanate-based, curable system. In certain embodiments, a third, intumescent flame-retardant ingredient provides a flame retardant system that is more effective than 1) any of the flame retardant ingredients alone in a two-part, isocyanate-based, curable system and 2) the same flame retardant system without the added third ingredient.

### PRIORITY CLAIM

The present non-provisional patent Application claims priority under 35 USC §119(e) from United States Provisional Patent Application having Ser. No. 60/645,331, filed on Jan. 20, 2005, by Gupta et al., and titled FLAME RETARDANT SYSTEMS, AND RELATED METHODS AND USES, wherein the entirety of said provisional patent application is incorporated herein by reference.

### FIELD OF INVENTION

The present invention relates to flame retardant systems and related methods and uses of such flame retardant systems. One exemplary use of a flame retardant system according to the present invention is in two-part, isocyanate-based, curable systems.

### BACKGROUND OF THE INVENTION

Flame retardants are well-known and are typically added to and/or applied as a surface treatment to help prevent the spread of fire and/or protect a material exposed to fire. There is a large variety of commercially available flame retardants that generally includes bromine-based flame retardants, phosphorous-based flame retardants (e.g., ammonium polyphosphate(APP)), nitrogen-based flame retardants (e.g., melamine), inorganic-based flame retardants, and chorine-based flame retardants. For quite some time there has been a desire to shift away from halogenated flame retardant ingredients such as bromine and chlorine based flame retardants.

A flame retardant can also be classified by the mechanism in which it acts as a flame retardant. A well-known flame retarding mechanism is known as “intumescence,” and is attributable to the flame retardant category known as “intumescents.” Intumescent flame retardants expand and form a char layer as a barrier between the underlying material and surrounding environment.

Flame retardants can be used with a wide variety of items such as furniture, floors (e.g., floor coverings), decks (e.g., deck coverings), textiles, cables, building materials and insulation, electrical equipment, transportation equipment (e.g., truck-bed liners), roofs (e.g., roof coating), and the like. Flame retardants are desirably used in two-part, isocyanate-base, curable systems to provide cured compositions with flame retardancy, but often such use is not a reality because of technical hurdles involved in incorporating flame retardants in two-part, curable systems.

Two-part, isocyanate-based, curable systems are well-known. Such systems generally include a compound having isocyanate functionality (NCO functionality) in a first part (or A-side) and a material reactive with the NCO functionality in a second part (or B-side). The first part and second part are typically stored in separate packages/containers until it is time to form the cured composition. At the time of use (i.e., time to form a cured composition) the first and second parts of such systems can be mixed together, applied to a surface or used in a desired manner, and allowed to cure (often at relatively low temperatures such as room temperature) to form a cured composition, such as a coating having useful properties such as a wide range of flexibility yet suitable toughness, high abrasion resistance, high chemical resistance, high acid etch resistance, high weatherability, and the like. Such coatings have found commercial success in vehicle products (e.g., truck bed liner), roof products (e.g., roof coating), and floor products (e.g., floor coating).

Materials that are reactive with isocyanate functionality to form such cured compositions include hydroxyl functional compounds to form polyurethanes, amine functional compounds to form polyureas, combinations of these, and the like.

Each part of the two-part curable system can desirably include additional ingredients that enhance the processing and/or handling of the parts (e.g., mixing the individual parts, mixing the parts together, applying the two-part mixture as a coating, and the like) and/or characteristics of the final cured composition. In general, it is desirable to incorporate the additional ingredients in one or both of the first and second parts so that fewer separate parts need to be handled prior to and at time of mixing the two parts. Optionally, additional components can be added as a third part at time of use (i.e., at the time of mixing the first and second part).

As mentioned, it is often desirable to include one or more flame retardants as additional ingredients in such two-part, isocyanate-based, curable systems. Certain desirable flame retardant ingredients, typically in solid form, for use in such curable systems are required to be present in relatively high amounts to be effective (e.g., greater than 25% by weight based on the total weight of the curable composition (e.g., first and second parts together)). Such flame retardant ingredients might have to be allocated among the first and second parts because loading such high levels of solids in only one part (e.g., 25% by weight of the total curable system is typically about 50% by weight of one part) tends to make that part hard to process and handle (e.g., the viscosity of that part is too high). Unfortunately, some flame retardant ingredients such as the phosphate-based, ammonium polyphosphate, and nitrogen-based, melamine are reactive with the NCO functionality in the first part of a two-part, isocyanate-based, curable system, and can result in undue reaction with the NCO functionality, e.g., prior to use such as during storage, and can compromise physical properties, rheological properties, curing properties, etc. While if used alone, such flame retardant ingredients tend not to be sufficiently effective.

There is a continuing need for new and improved flame retardant systems, especially those that can be used in two-part, isocyanate-based, curable systems to provide useful flame retardant properties in the cured composition.

### SUMMARY OF THE INVENTION

Surprisingly, a flame retardant system has been discovered that includes a combination of at least two flame retardant ingredients that is more effective than either flame retardant ingredient alone in a two-part, isocyanate-based, curable system. Such a flame retardant system can be incorporated into a two-part, isocyanate-based, curable system without can result undue reaction with the NCO functionality thereby not compromising physical properties, Theological properties, curing properties, etc. At least one of the flame retardant ingredients is inert with respect to NCO functionality, which allows at least part of the inventive flame retardant system to be allocated among the first and second parts of a two-part, isocyanate-based system for easier processing and handling. Being able to allocate at least part of the inventive flame retardant system among the first and second parts of two-part, isocyanate-based systems is significant because it allow the use of certain flame retardant ingredients having reactivity with NCO functionality that were previously impractical to use because they needed to be incorporated at a solids level in the non-NCO part of a two-part system that made at least the non-NCO part too challenging to process and/or handle (e.g., making the viscosity of that part too high). According to the present invention, such flame retardant ingredients having reactivity with NCO functionality can be present at a relatively lower, more practical, solids level in the non-NCO part. Moreover, as mentioned, such flame retardant ingredients having reactivity with NCO functionality are more effective in the flame retardant system according to the present invention than by themselves in a two-part, isocyanate-based, curable system.

It has also been discovered that adding a third, intumescent flame-retardant ingredient (e.g., graphite-based flame retardant ingredient) to the flame retardant system above provides a flame retardant system that is even more effective than 1) any of the flame retardant ingredients alone in a two-part, isocyanate-based, curable system and 2) the same flame retardant system without the added third flame retardant ingredient.

In one aspect according to the present invention, an isocyanate-based, curable system includes a first part having: at least one ingredient having NCO functionality; and a first, phosphate-based flame retardant ingredient comprising a coating that is substantially inert with respect to the NCO functionality; and a second part having: at least one ingredient having a functionality that is co-reactive with the NCO functionality when the second part and first part are mixed together so as to form a cured composition; and a second flame retardant ingredient. In a preferred embodiment, the isocyanate-based, curable system further includes a third flame retardant ingredient having an intumescent characteristic. In preferred embodiments, the first flame retardant ingredient includes silicone-coated ammonium polyphosphate, the second flame retardant ingredient includes melamine-coated ammonium polyphosphate, and the third flame retardant ingredient includes expandable graphite flake.

### BRIEF DESCRIPTION OF THE DRAWINGS

FIG. 1 illustrates an exemplary horizontal flame test.

FIG. 2 illustrates an exemplary vertical flame test.

### DETAILED DESCRIPTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

In general, the present invention relates to providing a flame retardant system having at least first and second flame retardant ingredients that are more effective together than either flame retardant ingredient alone in a two-part, isocyanate-based, curable system.

A flame retardant system according to the present invention can be used in any two-part, isocyanate-based, curable system. Two-part, isocyanate-based, curable systems, and methods of making and using them are well known. See, e.g., U.S. Pat. No. 5,798,409 (Ho), U.S. Pat. No. 5,587,448 (Engen), and U.S. Pat. No. 5,183,877 (Swanson), the entireties of which references are incorporated herein by reference.

Exemplary two-part, isocyanate-based, curable systems useful with a flame retardant system according to the present invention are commercially available from, e.g., Polycoat Products, Santa Fe Springs, Calif., under the trade designations POLYEURO® MPL 55 and POLYEURO® 7502FR.

The first flame retardant ingredient is ordinarily reactive with NCO functionality but includes a coating that is substantially inert with respect to the NCO functionality. In preferred embodiments, the first flame retardant ingredient is halogen-free.

Preferably, the first flame-retardant ingredient is phosphate-based. Preferred phosphate-based flame retardant ingredients include polyphosphates, preferably ammonium polyphosphate (APP). APP and methods of making APP are well known as described in, e.g., U.S. Pat. No. 5,165,904 (Staffel et al.), U.S. Pat. No. 5,277,887 (Staffel et al.), and U.S. Pat. No. 5,213,783 (Fukumura et al.), the entireties of which references are incorporated herein by reference.

As mentioned, the first flame retardant ingredient includes a coating that is substantially inert with respect to the NCO functionality. Having an inert coating with respect to NCO functionality allows at least part of the first flame retardant ingredient to be allocated among the first and second parts of a two-part, isocyanate-based system for easier processing and handling. Advantageously, this allows certain flame retardants that are ordinarily reactive with NCO functionality (e.g., APP and the like) to be coated with an inert coating and, preferably, allocated at least partially into the NCO functional part (i.e. side A) of a two-part, isocyanate-based systems so that each part has a manageable level of solids and so that the flame retardant ingredient is present in the overall curable system at levels that provide suitable flame retardancy. Useful inert coatings include coatings containing a silicone material, a fluorine material, an olefinic material, combinations of these, and the like. A coating for the first flame retardant ingredient that is inert with respect to NCO functionality preferably includes an inorganic constituent, preferably a silicone-containing constituent. Coated APP and methods of coating APP are well known as described in, e.g., U.S. Pat. No. 6,291,068 (Wang et al.), U.S. Pat. No. 5,599,626 (Fukumura et al.), and U.S. Pat. No. 5,534,291 (Fukumura et al.), the entireties of which references are incorporated herein by reference.

According to the present invention, the inert coating of the first flame retardant ingredient has sufficient coverage and thickness so as to render the first flame retardant ingredient substantially inert with respect to NCO functionality (no undue reaction between the first flame retardant ingredient and the NCO functionality).

A preferred silicone coated, APP flame retardant ingredient for use in the present invention is commercially available from JLS Flame Retardants Chemical Inc., Pomona, Calif., under the tradename JLS-APP102. Such silicone coated APP is inert with respect both parts (side A and B) of a two-part, isocyanate-based, curable system and can be loaded in side A and/or side B, preferably in side A.

The first flame retardant ingredient can be present in the first part and/or second part of a two-part, isocyanate-based, curable system, preferably in the first part in an amount in the range from 1 to 40 weight percent based on the total weight of the first part, more preferably in an amount in the range from 10-40 weight percent based on the total weight of the first part, even more preferably in an amount in the range from 15 to 40 weight percent based on the total weight of the first part, even more preferably in an amount in the range from 20 to 40 weight percent based on the total weight of the first part, and even more preferably in an amount in the range from 30 to 35 weight percent based on the total weight of the first part.

The first flame retardant ingredient can be present in a two-part, isocyanate-based, curable system as a whole, in an amount in the range from 0.5 to 20 weight percent based on the total weight of the curable system, more preferably in an amount in the range from 5 to 20 weight percent based on the total weight of the curable system, even more preferably in an amount in the range from 7.5 to 20 weight percent based on the total weight of the curable system, even more preferably in an amount in the range from 10 to 20 weight percent based on the total weight of the curable system, and even more preferably in an amount in the range from 15 to 17.5 weight percent based on the total weight of the curable system.

The second flame retardant ingredient is inert with the functionality that is co-reactive with the NCO functionality in a two-part, curable system. For example, the second flame retardant ingredient is inert with respect to hydroxyl functionality, amine functionality, combinations of these, and the like, as is appropriate for the chemistry of the second part (side B).

The second flame retardant ingredient can include any kind of flame retardant ingredient, preferably so it can be loaded in the second part of a two-part, NCO functional, curable system (i.e., as long as it is inert with the functionality that is co-reactive with the NCO functionality). Such flame retardants are well known and can include flame retardants such as bromine-based flame retardants, phosphorous-based flame retardants (e.g., ammonium polyphosphate(APP)), nitrogen-based flame retardants (e.g., melamine), inorganic-based flame retardants, and chorine-based flame retardants. However, preferred second flame retardant ingredients are halogen-free.

Preferably, the second flame-retardant ingredient is phosphate-based. Preferred phosphate-based flame retardant ingredients include polyphosphates, preferably ammonium polyphosphate (APP).

In certain preferred embodiments, the second flame retardant ingredient includes a coating. Useful coatings are, likewise, preferably inert with the functionality that is co-reactive with the NCO functionality in a two-part, curable system and include coatings containing a silicone material, a fluorine material, an olefinic material, a nitrogen-based flame retardant material, combinations of these, and the like. A coating for the second flame retardant ingredient preferably includes a nitrogen-based flame retardant material, preferably a melamine-containing material.

A preferred melamine coated, APP flame retardant ingredient for use in the present invention is commercially available from JLS Flame Retardants Chemical Inc., Pomona, Calif., under the tradename JLS-APP101. This melamine coating has intumescent properties which enhances the flame retardance properties of the flame retardant system of the invention. Melamine may be reactive with NCO functionality, so such melamine coated, APP is preferably loaded in the second part of a two-part, isocyanate-based, curable system (i.e., side B).

The second flame retardant ingredient is preferably present in the second part of a two-part, isocyanate-based, curable system, in an amount in the range from Ito 40 weight percent based on the total weight of the second part, more preferably in an amount in the range from 10-40 weight percent based on the total weight of the second part, even more preferably in an amount in the range from 15 to 40 weight percent based on the total weight of the second part, even more preferably in an amount in the range from 20 to 40 weight percent based on the total weight of the second part, and even more preferably in an amount in the range from 30 to 35 weight percent based on the total weight of the second part.

The second flame retardant ingredient can be present in a two-part, isocyanate-based, curable system as a whole, in an amount in the range from 0.5 to 20 weight percent based on the total weight of the curable system, more preferably in an amount in the range from 5 to 20 weight percent based on the total weight of the curable system, even more preferably in an amount in the range from 7.5 to 20 weight percent based on the total weight of the curable system, even more preferably in an amount in the range from 10 to 20 weight percent based on the total weight of the curable system, and even more preferably in an amount in the range from 15 to 17.5 weight percent based on the total weight of the curable system.

Relative amounts of the first and second flame retardant ingredient in the whole curable system include those that provide suitable flame retardant properties to a cured composition obtained from a two-part, isocyanate-based, curable system. A preferred ratio of parts by weight first flame retardant ingredient per parts by weight second flame retardant ingredient for the whole curable system (e.g., for the first and second parts) includes a ratio in the range from 1:20 to 20:1, preferably in the range from 5:1 to 1:5, more preferably in the range from 2:1 to 1:2, and even more preferably about 1:1.

Optionally, one or more additional flame retardant ingredients can be incorporated into a two-flame retardant ingredient system according to the present invention. Preferably, such additional flame retardant ingredients are halogen-free. In preferred embodiments, the one or more additional flame retardant ingredients have an intumescent characteristic. In preferred embodiments, the additional flame retardant ingredient(s) include graphite-containing material, such as expandable graphite flake. Expandable graphite is commercially available from Nyacol Nano Technologies, Inc., Ashland, Mass., under the tradename NYACOL® NYAGRAPH and from Graftach, Cleveland, Ohio, under the tradename GRAFGUARD 220-80N.

An optional, third flame retardant ingredient can be present in the first part, second part, and/or a third part (i.e., third stream at time of mixing) of a two-part, isocyanate-based, curable system in an amount in the range from 1 to 15 weight percent based on the total weight of a part, more preferably in an amount in the range from 5 to 10 weight percent based on the total weight of a part.

An optional third flame retardant ingredient can be present in a two-part, isocyanate-based, curable system as a whole, in an amount in the range from 0 to 15 weight percent based on the total weight of the curable system, more preferably in an amount in the range from 5 to 10 weight percent based on the total weight of the curable system.

A preferred flame retardant system according to the present invention includes at least a first flame retardant ingredient including silicone-coated ammonium polyphosphate and a second flame retardant ingredient including melamine-coated ammonium polyphosphate.

Another preferred flame retardant system according to the present invention includes at least a first flame retardant ingredient including silicone-coated ammonium polyphosphate, a second flame retardant ingredient including melamine-coated ammonium polyphosphate, and a third flame retardant ingredient, preferably an intumescent flame retardant ingredient such as expandable graphite flake.

As mentioned, flame retardant systems according to the present invention are especially useful in two-part, isocyanate-based, curable systems. Two-part curable systems can be mixed at time of use by using equipment and methods known in the art for mixing two-part, isocyanate-based system together.

Depending on factors such as material handling and/or processing, any additional flame retardant ingredients can be incorporated into the first and/or second part prior to combining the first and second parts at time of use and/or can be mixed in with the first and second parts at the time of use. In preferred embodiments, optional expandable graphite flake is provided as a third part at the time of mixing the first part and second part to provide a mixture. Because expandable graphite flake is typically sensitive to shear it can break if subjected to undue shear. For example, if expandable graphite flake is mixed in an impingement gun with a two-part curable system, it is very susceptible to breaking and/or plugging the dispensing orifice of the gun, both of which are highly undesirable. Accordingly, in preferred embodiments, expandable graphite flake is incorporated into the curable system as a separate part and mixed in with the first and second parts at time of use (e.g., external to an impingement gun). Adding any additional flame retardant ingredient at time of use can be performed with equipment and methods known in the art.

Optionally, two-part, isocyanate-based, curable systems can incorporate one or more additional ingredients in the first part, second part, and/or at time of mixing the first and second part as is understood in the art, such as, to help processing, coating, curing, and/or final cured composition properties. Such optional ingredients include, but are not limited to fillers, flow control agents, bubble control agents, free radical scavengers, ultraviolet light absorbers, fungicides, bacteriocides, dyes, pigments, aluminum flakes, reaction inhibitors, pot life extenders, biocides, mixtures thereof, etc.

For example, it can be highly desirable to optionally incorporate filler with a two-part system. The filler can be incorporated into the first part and/or the second part of the system and/or can be added at the time of mixing the first part and the second part together. Useful filler includes organic and/or inorganic filler. Exemplary inorganic filler includes sand, titania, clay, silica, fumed silica, combinations thereof, etc. Exemplary organic filler includes PVC, polystyrene, polypropylene, polyethylene, other olefinic fillers, combinations thereof, and the like. Preferred filler includes polyolefinic material such as polyethylene beads and/or polypropylene beads. Polyolefinic beads are lightweight and help provide cured compositions with high chemical resistance and high abrasion.

Suitable pigments include titanium dioxide, phthalocyanine blue, carbon black, basic carbonate white lead, zinc oxide, zinc sulfide, antimony oxide, zirconium oxide, lead sulfochromate, bismuth vanadate, bismuth molybdate, combinations thereof, etc.

After mixing a two-part, isocyanate-based, curable system, it can be applied to a surface or otherwise used by methods known in the art. The cured compositions can be used in a variety of products, especially vehicle products (e.g., coating in truck bed liner), roof products (e.g., roof coating), floor products (e.g., floor coating), and the like.

### EXAMPLES

Representative embodiments of the present invention will now be described with reference to the following examples that illustrate the principles and practice of the present invention.

General Procedure for Testing Flame Retardancy

Strips of material formulated according to the Examples below were evaluated for flame retardancy by subjecting the strips to a horizontal and vertical flame test, observing their burning behavior (if any), and then recording various fire retardance characteristics for each Example. The flame tests (horizontal and vertical) described below were devised to be carried out in a relatively simple manner, yet able explain the complexity of an Example's burning characteristics. Such a simple, yet very informative, testing procedure is extremely useful.

In more detail, for each Example, strips of material about 0.5 inches wide and about 3 to 6 inches long were cut from a film of material made from components according to the Example formulations below (film making further discussed below).

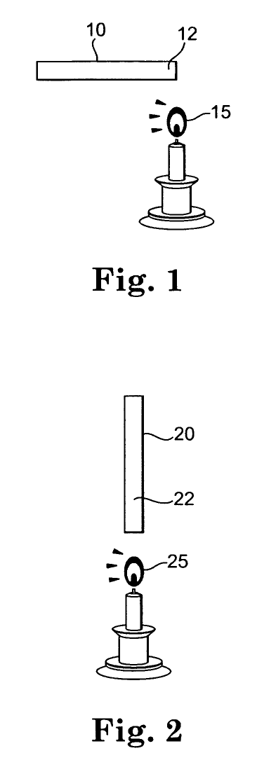

For the horizontal flame test, a given strip 10 was held at one end with a tong-like instrument (not shown) in the horizontal position so that the other end 12 was positioned in a candle-flame 15 as shown below in FIG. 1.

For the vertical flame test, another strip 20 from the film for a given Example was held at one end with a tong-like instrument (not shown) in the vertical position so that the other end 22 was positioned in a candle-flame 25 as shown below in FIG. 2.

For each of the horizontal and vertical flame tests, after the strip was subjected to the flame, it was observed whether or not the strip began to burn. If the strip appeared to be burning, it was removed from the flame and observed whether the burning strip self-propagated and/or self-extinguished. If the burning strip self-extinguished, it was placed in the flame again until it started burning and observed as described above. These steps were repeated until the entire strip was consumed by burning. The total time for burning the entire strip was recorded for each of the horizontal and vertical flame tests (note: if a strip did not burn, a time was not recorded for that particular flame test). For each Example, the following characteristics were recorded: whether or not the flame was self-propagating, whether or not the flame self-extinguished, whether or not a fibrous structure formed on the surface of the strip, whether or not char formed on the surface of the strip, whether or note the material dripped as it burned, and the color of the smoke (the more white the color of smoke is tends to be indicative of a cleaner burning material). Also, a smoke density and fire rating were assigned to each example. Smoke density and fire rating were rated on the following scales:

Smoke Density:
1=lowest smoke.
5=highest smoke.

Fire Rating:
1=burns completely; fast self propagation in the horizontal burn test.
3=does not self extinguish, but self propagates relatively slowly in the horizontal burn test.
7=burns for about 5-10 seconds after removal from flame in horizontal burn test and then self extinguishes.
10=self extinguishes immediately after flame is removed in horizontal burn test.
   List of Ingredients

The following ingredients were used as indicated in the Examples below:

IPDI (isophorone diisocyanate), commercially available from DeGussa, Performance Products Corp, 65 Challenger Road, Ridgefield Park, N.J. 07660.

PLURACOL-2010 (polyether diol), commercially available from BASF, 3000 Continental Drive No., Mount Olive, N.J. 07828.

DBPC TECH GRADE (butylated hydroxyl toluene), commercially available from Acros Organics, N.V., 1, Reagent Ln., Fair Lawn, N.J. 07410.

PLURACOL-1421 (polyether triol), commercially available from BASF, 3000 Continental Drive No., Mount Olive, N.J. 07828.

METACURE T-12 (dibutyltin dilaurate), commercially available from Air Products & Chemicals, Inc., 7201 Hamilton Blvd., Allentown, Pa. 18195.

APP-102 (silicone coated ammonium polyphosphate), commercially available from JLS Flame Retardant Chemicals, Pomona, Calif.

JEFFSOL PC (propylene carbonate), commercially available from Huntsman Chemical Corp., P.O. Box 27707, Houston, Tex. 77227.

TINUVIN 1130 (polymeric benzotriazle), commercial available from CIBA Specialty Chemicals, 540 White Plains Road, P.O. Box 2005, Tarrytown, N.Y. 10591.

TINUVIN 292 (bis(1,2,2,6,6-pentamethyl-4-piperidinyl)sebacate, commercially available from CIBA Specialty Chemicals, 540 White Plains Road, P.O. Box 2005, Tarrytown, N.Y. 10591.

BYK-361N (polyacrylate copolymer), commercially available from BYK-Chemie 524 S. Cherry St., Wallingford Conn. 06492.

SAG-47 (polydimethyl siloxane), commercially available from GE SILICONES, Wilton, Conn. 06897.

APP-101 (melamine coated ammonium polyphosphate), commercially available from JLS Flame Retardant Chemicals, Pomona, Calif.

ETHACURE 100 (DETDA), commercially available from Albemarle, 451 Florida St., Baton Rouge, La. 70801.

DINP (1,2 benzene dicarboxylic acid), commercially available from ExxonMobil Chemical Co., 13502 Katy Fwy, Houston, Tex. 77079-1398.

MINUSIL 10 (ground silica), commercially available from U.S. Silica, P.O. Box 187, Berkeley Springs, W. Va. 25411.

NYAGRAPH 35 (expandable graphite flame retardant additive), commercially available from Nyacol Nano Technologies Inc., P.O. Box 349, Ashland, Mass. 01721.

DISPERSPLAST 1142 (dispersion agent), commercially available from BYK-Chemie, 524 S. Cherry St., Wallingford Conn. 06492.

AEROSIL R 972 (hydrophobic silicon dioxide), commercially available from Degussa Huls, Performance Products Corp, 65 Challenger Road, Ridgefield Park, N.J. 07660.

SILQUEST A 187 (trimethoxysiloxane), commercially available from OSI Specialties, 1 American Ln., Greenwhich, Conn. 06831.

BYK-163 (dispersion agent), commercially available from BYK-chemie, BYK-Chemie, 524 S. Cherry St., Wallingford Conn. 06492.

TI-PURE R 960 (titanium dioxide), commercially available from Dupont, Dupont-Engineering, Chesnut Run Plaza, Bld 713, Willmington, Del. 19880-0713.

POLYEURO MPL-55, Side A of two-part, isocyanate-based, curable system, Batch #20410025, commercially available from Polycoat Products, Santa Fe Springs, Calif.

POLYEURO MPL-55, Side B of two-part, isocyanate-based, curable system, Batch #20410024, commercially available from Polycoat Products, Santa Fe Springs, Calif.

POLYEURO 7502, Side A of two-part, isocyanate-based, curable system, commercially available from Polycoat Products, Santa Fe Springs, Calif.

POLYEURO 7502, Side B of two-part, isocyanate-based, curable system, commercially available from Polycoat Products, Santa Fe Springs, Calif.

GRAFGUARD 220-80N (expandable graphite), commercially available from Graftach, Cleveland, Ohio.

White Paste: The White Paste was made by mixing together the following ingredients in the order listed (percentages are weight percentage of ingredient based on total weight of white paste): 28.1% DINP; 0.71% DISPERSPLAST 1142; 0.95% BYK-163; and 70.24% TI-PURE R 960.

### Procedure for Preparing Examples 1-5

Examples 1-5 were made by mixing together a first part (A-side) and second part (B-side) and allowing them to cure to form the cured compositions of Examples 1-5, respectively.

The A-side was prepared by adding IPDI, PLURACOL 2010 (polyether diol), and METACURE T-12 (dibutyltin dilaurate catalyst) to a mixing batch reactor and mixing for about 20 minutes. After mixing, the mixture was heated to 220° F. for about 90 minutes to facilitate reaction to provide a suitable NCO content. After mixing, a premix was added to the batch reactor. The premix was made by adding PLURACOL 1421 (polyether triol), JEFFSOL PC (propylene carbonate), and “white paste” into an open pot and mixing to incorporate the ingredients. The premix was mixed into the batch reactor and the mixture was heated to 220° F. for about 90 minutes to facilitate reaction to provide a suitable NCO content. After adding the premix and allowing reaction to occur, the remaining ingredients listed in the TABLE 1-A below were added to the A-side. After mixing together all of the A-side ingredients, the mixture was degassed and cooled to about 130 to 140° F. and packaged in a suitable container.

TABLE 1-A
Ingredients for A-side in Examples 1-5

| | Weight Percent based on total weight of A-side | | | | |
|---|---|---|---|---|---|
| Ingredient | Example 1 | Example 2 | Example 3 | Example 4 | Example 5 |
| IPDI | 16.81 | 16.81 | 16.81 | 14.00 | 14.00 |
| PLURACOL 2010 | 57.40 | 57.40 | 57.40 | 47.83 | 47.83 |
| (polyether diol) | | | | | |
| METACURE T-12 | 0.09 | 0.09 | 0.09 | 0.08 | 0.08 |
| (dibutyltin dilaurate) | | | | | |
| DBPC TECH GRADE | 1.00 | 1.00 | 1.00 | 0.83 | 0.83 |
| (butylated hydroxyl toluene) | | | | | |
| PLURACOL 1421 | 15.73 | 15.73 | 15.73 | 13.10 | 13.10 |
| (polyether triol) | | | | | |
| APP-102 | 0.00 | 0.00 | 0.00 | 16.66 | 16.66 |
| (silicone coated | | | | | |
| ammonium phosphate) | | | | | |
| JEFFSOL PC | 6.88 | 6.88 | 6.88 | 5.73 | 5.73 |
| (propylene carbonate) | | | | | |
| White Paste | 0.98 | 0.98 | 0.98 | 0.83 | 0.83 |
| TINUVIN 1130 | 0.20 | 0.20 | 0.20 | 0.17 | 0.17 |
| (polymeric benzotriazle) | | | | | |
| TINUVIN 292 | 0.60 | 0.60 | 0.60 | 0.50 | 0.50 |
| (bis(1,2,2,6,6,pentamethyl- | | | | | |
| 4-piperidinyl)sebacate) | | | | | |
| BYK - 361N | 0.29 | 0.29 | 0.29 | 0.25 | 0.25 |
| (polyacrylate copolymer) | | | | | |
| SAG-47 | 0.02 | 0.02 | 0.02 | 0.02 | 0.02 |
| (polydimethyl copolymer) | | | | | |

The B-side was prepared by mixing all of the ingredients listed in the TABLE 1-B below in a sequential order (adding one ingredient after another ingredient) in a pot at room temperature and then packaging in a suitable container.

TABLE 1-B
Ingredients for B-side in Examples 1-5

| | Weight Percent based on total weight of B-side | | | | |
|---|---|---|---|---|---|
| Ingredient | Example 1 | Example 2 | Example 3 | Example 4 | Example 5 |
| White Paste | 45.79 | 40.00 | 40.00 | 34.31 | 35.55 |
| APP-101 | 0.00 | 0.00 | 40.00 | 25.70 | 37.31 |
| (melamine coated | | | | | |
| ammonium polyphosphate) | | | | | |
| APP-102 | 0.00 | 40.00 | 0.00 | 0.00 | 0.00 |
| (silicone coated | | | | | |
| ammonium polyphosphate) | | | | | |
| ETHACURE 100 | 3.68 | 3.90 | 3.90 | 4.05 | 4.14 |
| (DETDA) | | | | | |
| DINP | 17.92 | 14.00 | 14.00 | 20.60 | 21.32 |
| (1,2 benzene | | | | | |
| dicarboxylic acid) | | | | | |
| MINUSIL 10 | 30.00 | 0.00 | 0.00 | 0.00 | 0.00 |
| (ground silica) | | | | | |
| NYAGRAPH 35 | 0.00 | 0.00 | 0.00 | 13.72 | 0.00 |
| (expandable graphite) | | | | | |
| DISPERSPLAST 1142 | 0.00 | 0.00 | 0.00 | 0.43 | 0.44 |
| (dispersion agent) | | | | | |
| AEROSIL R 972 | 0.50 | 0.50 | 0.50 | 0.21 | 0.22 |
| (hydrophobic silicon dioxide) | | | | | |
| SAG-47 | 0.01 | 0.01 | 0.01 | 0.04 | 0.04 |
| (polydimethyl siloxane) | | | | | |
| BYK-361N | 0.30 | 0.30 | 0.30 | 0.26 | 0.27 |
| (polyacrylate copolymer) | | | | | |
| TINUVIN 292 | 0.60 | 0.60 | 0.60 | 0.51 | 0.53 |
| (bis(1,2,2,6,6-pentamethyl- | | | | | |
| 4-piperidinyl)sebacate | | | | | |
| TINUVIN 1130 | 0.20 | 0.20 | 0.20 | 0.17 | 0.18 |
| (polymeric benzotriazle) | | | | | |
| SILQUEST A-187 | 1.00 | 1.00 | 1.00 | 0.00 | 0.00 |
| (trimethylsiloxane) | | | | | |

Examples 1-5 were then prepared by adding about 4 ounces of the A-side composition and about 4 ounces of the B-side composition into a 16 ounce plastic cup at room temperature. The contents were mixed at a slow speed for about 3 minutes. After mixing, a portion of the mixed composition was poured onto a mold-release glass substrate to form a film. A doctor blade was used to manually spread the mixed composition over the glass substrate to provide a film thickness of about 35 mils to about 38 mils. The glass substrates were about 4 feet wide and 2 feet long. After applying the composition to the substrate, the composition was allowed to cure for about 7 days at 75-80° F. After curing, the sample was removed from glass substrate and tested for flame retardancy as described above. The test results are summarized in TABLE 5 below.

### Procedure for Preparing Examples 6-11

Examples 6-11 were made by first sequentially mixing together the ingredients indicated in Table 2 below at room temperature. That is, an amount of the side A formulation for Example 1 was mixed with an amount of the side B formulation for Example 1, and optionally, one or more of APP-101 (melamine coated ammonium polyphosphate), APP-102 (silicone coated ammonium polyphosphate), and expandable graphite as indicated in TABLE 2. The ingredients were mixed at a slow speed for about 3 minutes. After mixing, a portion of the mixed composition was poured onto a mold-release glass substrate to form a film. A doctor blade was used to manually spread the mixed composition over the glass substrate to provide a film thickness of about 35 mils to about 38 mils. The glass substrates were about 4 feet wide and 2 feet long. After applying the composition to the substrate, the composition was allowed to cure for about 7 days at 75-80° F. After curing, the sample was removed from glass substrate and tested for flame retardancy as described above. The test results are summarized in TABLE 5 below.

TABLE 2
Ingredients for Examples 6-11

| | Weight Percent based on total weight of | | | | | |
|---|---|---|---|---|---|---|
| | all ingredients for a given Example | | | | | |
| Ingredient | Ex. 6 | Ex. 7 | Ex. 8 | Ex. 9 | Ex. 10 | Ex. 11 |
| Ex. 1, Side A | 24.87 | 23.3 | 33.9 | 37.3 | 28.35 | 26.3 |
| Ex. 1, Side B | 41.8 | 39.2 | 57 | 62.7 | 47.67 | 44.2 |
| APP-101 | 16.7 | 15.6 | 0 | 0 | 17 | 16.5 |
| (melamine coated | | | | | | |
| ammonium | | | | | | |
| polyphosphate) | | | | | | |
| APP-102 | 16.7 | 15.6 | 0 | 0 | 7 | 5 |
| (silicone coated | | | | | | |
| ammonium | | | | | | |
| polyphosphate) | | | | | | |
| GRAFGUARD 220-80N | 0 | 6.25 | 9.1 | 0 | 0 | 8 |
| (expandable graphite) | | | | | | |

### Procedure for Preparing Examples 12-15

Examples 12-15 were made by mixing together a first part (A-side) and second part (B-side) and allowing them to cure to form the cured compositions of Examples 12-15, respectively.

For Examples 12-15, the A-side was prepared by sequentially adding and mixing together the ingredients indicated in TABLE 3-C, and then packaging the A-side in a suitable container.

TABLE 3-C
Ingredients for A-side in Examples 12-15

| | Weight Percent based on | | | |
|---|---|---|---|---|
| | total weight of A-side | | | |
| | Example | Example | Example | Example |
| Ingredient | 12 | 13 | 14 | 15 |
| POLYEURO MPL-55 | 85 | 75 | 70 | 100 |
| Side A of two-part | | | | |
| system | | | | |
| APP-102 (silicone | 0 | 25 | 23 | 0 |
| coated ammonium | | | | |
| polyphosphate) | | | | |
| GRAFGUARD 220-80N | 15 | 0 | 7 | 0 |
| (expandable graphite) | | | | |

For Examples 12-15, the B-side was prepared by sequentially adding and mixing together the ingredients indicated in TABLE 3-D, and then packaging the B-side in a suitable container.

TABLE 3-D
Ingredients for B-side in Examples 12-15

| | Weight Percent based on | | | |
|---|---|---|---|---|
| | total weight of B-side | | | |
| | Example | Example | Example | Example |
| Ingredient | 12 | 13 | 14 | 15 |
| POLYEURO MPL-55 | 85 | 75 | 70 | 100 |
| Side B of two-part | | | | |
| system | | | | |
| APP-101 (melamine | 0 | 25 | 23 | 0 |
| coated APP) | | | | |
| GRAFGUARD 220-80N | 15 | 0 | 7 | 0 |
| (expandable graphite) | | | | |

Examples 12-15 were then prepared by heating Side A (as indicated in Table 3-C) and Side B (as indicated in Table 3-D) to a temperature in the range from 150° F. to 160° F. on a hot plate. After heating, 150 ml of Side A was transferred to one cartridge and 150 ml of Side B was transferred to another cartridge. A static mixer was connected to each cartridge and using a pneumatic dispenser, Side A and Side B were dispensed into the static mixer so as to mix the material. The mixed material was dispensed from the static mixer onto a mold release glass substrate. Any static mixer could be used, but for these Examples a 24 element static mixer was used. After dispensing the mixture onto the glass, a doctor blade was used to manually spread the mixture over the glass substrate so as to provide a coating thickness of about 35 mils to about 38 mils. The glass substrates were 4 feet wide and 2 feet long. The mixture was allowed to cure for about 7 days at a temperature of about 75° F. to about 80° F. After curing, the sample was removed from glass substrate and tested for flame retardancy as described above. The test results are summarized in TABLE 5 below.

### Procedure for Preparing Examples 16 and 17

Examples 16 and 17 were made by mixing together a first part (A-side) and second part (B-side) and allowing them to cure to form the cured compositions of Examples 16 and 17, respectively.

The A-side and B-side of Example 16 consisted of the A-side and B-side, respectively, of POLYEURO®07502 as indicated in TABLE 4-A.

For Example 17, the A-side was prepared by adding and mixing APP 102 into POLYEURO®7502 Side A as indicated in TABLE 4-A. The mixture was allowed to sit overnight and then packaged in a suitable container.

TABLE 4-A
Ingredients for A-side in Examples 16 and 17

| | Weight Percent based on | |
|---|---|---|
| | total weight of A-side | |
| Ingredient | Example 16 | Example 17 |
| POLYEURO 7502 Side A of two-part | 100 | 75.00 |
| system | | |
| APP-102 (silicone coated APP) | 0 | 25.00 |

For Example 17, the B-side was prepared by sequentially adding and mixing together the ingredients indicated in TABLE 4-B, and then packaging in a suitable container.

TABLE 4-B
Ingredients for B-side in Examples 16 and 17

| | Weight Percent based on | |
|---|---|---|
| | total weight of B-side | |
| Ingredient | Example 16 | Example 17 |
| POLYEURO 7502FR Side B of two-part | 100 | 75.00 |
| system | | |
| APP-101 (melamine coated APP) | 0 | 25.00 |

Examples 16 and 17 were then prepared by heating Side A (as indicated in Table 4-A) and Side B (as indicated in Table 4-B) to a temperature in the range from 150° F. to 160° F. on a hot plate. After heating, 150 ml of Side A was transferred to one cartridge and 150 ml of Side B was transferred to another cartridge. A static mixer was connected to each cartridge and using a pneumatic dispenser, Side A and Side B were dispensed into the static mixer so as to mix the material. The mixed material was dispensed from the static mixer onto a mold release glass substrate. Any static mixer could be used, but for these Examples a 24 element static mixer was used. After dispensing the mixture onto the glass, a doctor blade was used to manually spread the mixture over the glass substrate so as to provide a coating thickness of about 35 mils to about 38 mils. The glass substrates were 4 feet wide and 2 feet long. The mixture was allowed to cure for about 7 days at a temperature of about 75° F. to about 80° F. After curing, the sample was removed from glass substrate and tested for flame retardancy as described above. The test results are summarized in TABLE 5 below.

TABLE 5
Flame Retardance Test Results for Examples 1-17

| | | | | | Time | | Time | | | | | |
|---|---|---|---|---|---|---|---|---|---|---|---|---|
| | | | | Horizontal | (sec) to | Vertical | (sec) to | | | | | |
| | % APP-101 | % APP-102 | % | Test | burn for | Test | burn for | | Fibrous | Char | | |
| | (melamine | (silicone | Expandable | (Type of | Horiz. | (Type of | Vert. | Smoke | Struc- | Forma- | Smoke | Fire |
| Ex. | coated APP | coated APP) | Graphite | Burning) | Test | Burning) | Test | Color | ture | tion | Density | Rating |
| 1 | 0 | 0 | 0 | propagating, | 73 | propagating, | 20 | black | No | No | 5 | 1 |
| | | | | dripping | | dripping | | | | | | |
| 2 | 0 | 24.6 | 0 | propagating, | 90 | propagating, | 20 | white | No | No | 3 | 1 |
| | | | | dripping | | dripping | | | | | | |
| 3 | 24.6 | 0 | 0 | propagating, | 58 | propagating, | 25 | white | No | No | 2 | 2 |
| | | | | dripping | | dripping | | | | | | |
| 4 | 14.3 | 7.4 | 7.65 | propagating, | 60 | propagating, | 23 | white | Yes | Yes | 2-3 | 3 |
| | | | | dripping, | | dripping, | | | | | | |
| | | | | creating | | creating | | | | | | |
| | | | | fibrous | | fibrous | | | | | | |
| | | | | structure | | structure | | | | | | |
| | | | | and film has | | and film has | | | | | | |
| | | | | no strength | | no strength | | | | | | |
| | | | | so burns | | so burns | | | | | | |
| | | | | down further | | down further | | | | | | |
| 5 | 20.5 | 7.5 | 0 | propagating | 135 | propagating, | 25 | white | No | No | 2 | 6-7 |
| | | | | slowly, | | dripping | | | | | | |
| | | | | dripping | | | | | | | | |
| 6 | 16.67 | 16.67 | 0 | burns, drips | 120 | propagating, | 30 | white | No | No | 2 | 7-8 |
| | | | | and fire | | dripping | | | | | | |
| | | | | extinguishes | | | | | | | | |
| 7 | 15.6 | 15.6 | 6.25 | as film is | — | dripfire | — | white | Yes | Yes | 2 | 9-10 |
| | | | | removed | | stops | | | | | | |
| | | | | from the | | propagating | | | | | | |
| | | | | flame fire | | as film | | | | | | |
| | | | | extinguishes | | drips and self | | | | | | |
| | | | | | | extinguishes | | | | | | |
| 8 | 0 | 0 | 9.1 | burns all | 30 | burns all | 30 | black | Yes | Yes | 4 | 1 |
| | | | | the way as | | the way as | | | | | | |
| | | | | film has no | | film has no | | | | | | |
| | | | | strength | | strength | | | | | | |
| | | | | and fibrous | | and fibrous | | | | | | |
| | | | | structure | | structure | | | | | | |
| | | | | is hardly | | is hardly | | | | | | |
| | | | | formed | | formed | | | | | | |
| 9 | 0 | 0 | 0 | propagating, | 73 | propagating, | — | black | No | No | 5 | 1 |
| | | | | dripping | | dripping | | | | | | |
| 10 | 17 | 7 | 0 | burns and | 95 | propatating, | 23 | white | No | No | 2 | 4-5 |
| | | | | fire | | dripping | | | | | | |
| | | | | extinguishes | | | | | | | | |
| | | | | because | | | | | | | | |
| | | | | of dripping | | | | | | | | |
| 11 | 16.5 | 5 | 8 | as film is | — | fire stops | — | white | Yes | Yes | 2 | 8-9 |
| | | | | removed | | propagating | | | | | | |
| | | | | from the | | as film drips | | | | | | |
| | | | | flame fire | | and self | | | | | | |
| | | | | extinguishes | | extinguishes | | | | | | |
| 12 | 0 | 0 | 14.3 | as film is | — | fire | 20 | black | Yes | Yes | 4 | 6-7 |
| | | | | removed | | propagates | | | | | | |
| | | | | from the | | all the way | | | | | | |
| | | | | flame fire | | | | | | | | |
| | | | | extinguishes | | | | | | | | |
| 13 | 11.9 | 11.9 | 0 | as film is | — | propagating | 15 | white | No | No | 2 | 6 |
| | | | | removed | | | | | | | | |
| | | | | from the | | | | | | | | |
| | | | | flame fire | | | | | | | | |
| | | | | extinguishes | | | | | | | | |
| 14 | 10.95 | 10.95 | 6.67 | no | — | no propagation, | — | white | Yes | Yes | 1-2 | 9-10 |
| | | | | propagation, | | self | | | | | | |
| | | | | self | | extinguishing, | | | | | | |
| | | | | extinguishing, | | no dripping | | | | | | |
| | | | | no dripping | | | | | | | | |
| 15 | 0 | 0 | 0 | propagating, | 90 | propagating, | 20 | black | No | No | 4-5 | 2-3 |
| | | | | dripping | | dripping | | | | | | |
| 16 | 0 | 0 | 0 | propagating, | 90 | propagating, | 20 | black | No | No | 4-5 | 2-3 |
| | | | | dripping | | dripping | | | | | | |
| 17 | 12.43 | 12.37 | 0 | drips but | — | drips but | — | white | No | No | 1-2 | 7-8 |
| | | | | fire | | fire | | | | | | |
| | | | | extinguishes | | extinguishes | | | | | | |

Notes:
1) The percentage amounts of APP-101 (melamine coated APP), APP-102 (silicone coated APP), and Expandable Graphite are weight percentages based on the total weight of all ingredients for the given Example; and
2) The time to burn is for burning the entire strip.

What is claimed is:

1. An isocyanate-based, curable system comprising:
a. a first part comprising:
i. at least one ingredient having NCO functionality; and
ii. a first, phosphate-based flame retardant ingredient comprising a coating that is substantially inert with respect to the NCO functionality; and
b. a second part comprising:
i. at least one ingredient having a functionality that is co-reactive with the NCO functionality when the second part and first part are mixed together so as to form a cured composition; and
ii. a second flame retardant ingredient.

2. The isocyanate-based, curable system of claim 1, wherein the first, phosphate-based flame retardant ingredient comprises a polyphosphate.

3. The isocyanate-based, curable system of claim 2, wherein the polyphosphate comprises ammonium polyphosphate.

4. The isocyanate-based, curable system of claim 1, wherein the coating on the first, phosphate-based flame retardant comprises a silicone-containing material.

5. The isocyanate-based, curable system of claim 1, wherein the second flame retardant ingredient comprises a coating comprising a melamine-containing material.

6. The isocyanate-based, curable system of claim 5, wherein the second flame retardant ingredient comprises ammonium polyphosphate.

7. The isocyanate-based, curable system of claim 1, wherein the curable system further comprises a third flame retardant ingredient having an intumescent characteristic.

8. The isocyanate-based, curable system of claim 7, wherein third flame retardant ingredient comprises a graphite-containing material.

9. The isocyanate-based, curable system of claim 8, wherein the graphite-containing material comprises expandable graphite flake.

10. A flame-retardant, isocyanate-based, cured coating, which is the reaction product of mixing the first and second parts of claim 1.

11. The cured coating of claim 10, wherein the coating forms a floor coating.

12. The cured coating of claim 10, wherein the coating forms a roof coating.

13. The cured coating of claim 10, wherein the coating forms a deck coating.

14. A method of making a flame-retardant, isocyanate-based, cured coating, the method comprising the steps of:
a. providing the first part of claim 1;
b. providing the second part of claim 1;
c. mixing the first part and second part to provide a mixture;
d. forming the mixture into a coating layer; and
e. allowing the coating to cure.

15. The method of claim 14, further comprising the step of providing expandable graphite flake in the mixture.

16. The method of claim 15, wherein the expandable graphite flake is provided as a third part at the time of mixing the first part and second part to provide a mixture.
